(19) United States
(12) Patent Application Publication
(10) Pub. No.: US 2007/0263023 A1
(43) Pub. Date: Nov. 15, 2007

(54) PRINTING APPARATUS AND METHOD FOR DETECTING AMOUNT OF PRINTING MATERIAL

(75) Inventor: Junhua ZHANG, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/749,056

(22) Filed: May 15, 2007

(30) Foreign Application Priority Data
May 15, 2006 (JP) 2006-134921

(51) Int. Cl. B41J 29/38

(52) U.S. Cl. 347/14; 347/20; 347/19; 347/9

(57) ABSTRACT

A printing apparatus which a printing material container is detachably mounted to. The printing material container has having a memory and a piezoelectric element for detecting the amount of a printing material contained therein. The printing apparatus includes an acquiring unit that acquires frequency information regarding the frequency of a driving signal for driving the piezoelectric element from the memory; a supplying unit that supplies the driving signal having a frequency that is determined based on the frequency information to the piezoelectric element; a detecting unit that detects a response signal that is outputted in response to vibration of the piezoelectric element after the stopping of supply of the driving signal; a measuring unit that measures vibration frequency of the piezoelectric element contained in the response signal; and a determining unit that determines whether the printing material is present in the printing material container of not based on the vibration frequency.

### BACKGROUND

1. Technical Field

The present invention generally relates to a printing apparatus, and more particularly to a method for detecting the amount of a printing material in a printing material container that is mounted to the printing apparatus.

2. Related Art

Some of ink containers that are designed to be mounted on an ink-jet-type printing apparatus are provided with sensors for detecting the remaining amount of ink. As such a sensor, for example, a piezoelectric element that has a tendency to expand and contract when a voltage is applied thereto is used. A sensor generates residual vibration after application of a voltage to a piezoelectric element, and outputs an output signal in response to the residual vibration. When detecting the amount of ink by means of a sensor having such a piezoelectric element, a printing apparatus applies a voltage to the piezoelectric element to measure the frequency of an output signal that is outputted from the sensor, thereby determining as to whether a certain amount of ink remains in the ink container or not. More specifically, the printing apparatus determines whether a certain amount of ink remains in the ink container by measuring the vibration frequency of the sensor that is contained in the output signal or not.

As an example of related art, JP-A-2003-39707 discloses that the frequency of a voltage applied to a piezoelectric element is used as resonance frequency for a sensor and ink contained in an ink container so that the amplitude of vibration of the sensor is made larger than otherwise, which contributes to improved precision in measurement of vibration frequency.

During a production process of a sensor for an ink container, a manufacturing error occurs; however, since a driving signal for driving a sensor is constant, an output signal that is outputted from the sensor could vary from one measurement to another even if the same amount of ink remains in the ink container. For this reason, depending on the margin of manufacturing error of a sensor as well as the remaining state of ink, the amplitude of vibration of a piezoelectric element could be small in some cases, which makes it difficult to measure the vibration frequency of the piezoelectric element with a high precision on a stable basis. As a result, there is a problem in that it is impossible to detect the amount of ink contained in an ink container with a high precision.

### SUMMARY

An advantage of some aspects of the invention is that the precision in determining the amount of ink contained in an ink container is improved.

In order to solve at least a part of the problems described above, as a first aspect, the present invention provides a printing apparatus that measures the amount of a printing material contained in a printing material container.

A printing apparatus according to an aspect of the invention is a printer which a printing material container is detachably mounted to, the printing material container having a memory and a piezoelectric element for detecting the amount of a printing material contained therein, the printer comprising: an acquiring section that acquires frequency information regarding the frequency of a driving signal for driving the piezoelectric element from the memory; a supplying section that supplies the driving signal having a frequency that is determined based on the frequency information to the piezoelectric element; a detecting section that detects a response signal that is outputted in response to vibration of the piezoelectric element after the stopping of supply of the driving signal; a measuring section that measures vibration frequency of the piezoelectric element contained in the response signal; and a determining section that determines whether the printing material is present in the printing material container or not based on the vibration frequency, wherein the frequency of the driving signal is a value obtained by multiplying a second reference frequency by 1/(2k+1) (where “k” denotes any arbitrary integer of 1 or greater), the second reference frequency being lower than a first reference frequency by a fixed percentage, the first reference frequency being the vibration frequency of the piezoelectric element when the printing material is not present in the printing material container.

According to a printing apparatus in an aspect of the invention, it is possible to supply a driving signal to a piezoelectric element at a driving signal frequency obtained by multiplying a second reference frequency by 1/(2k+1), where the second reference frequency is lower than a first reference frequency by a fixed percentage, which makes it further possible to improve the precision in detecting the amount of a printing material contained in a printing material container.

In a printing apparatus according to an aspect of the invention, it is preferable that the frequency information includes driving signal frequency information that specifies a frequency of the driving signal, and the supplying section supplies the driving signal to the piezoelectric element at a frequency specified by the driving signal frequency information.

With a printing apparatus according to an aspect of the invention, it is possible to acquire the frequency of a driving signal in a simple manner, thereby reducing the processing load of the printing apparatus.

In a printing apparatus according to an aspect of the invention, it is preferable that the frequency information includes a first reference frequency information that specifies the first reference frequency, and the printing apparatus further comprises a first determination section that calculates the second reference frequency based on the first reference frequency information and determines a value obtained by multiplying the calculated second reference frequency by 1/(2k+1) as the frequency of the driving signal.

In a printing apparatus according to an aspect of the invention, it is preferable that the frequency information includes a second reference frequency information that specifies the second reference frequency, and the printing apparatus further comprises a second determination section that determines a value obtained by multiplying the second reference frequency specified by the second reference frequency information by 1/(2k+1) as the frequency of the driving signal.

With a printing apparatus according to an aspect of the invention, it is possible to calculate the frequency of a driving signal that is suitable for detecting the amount of a printing material contained in a printing material container by using frequency information that is acquired from a memory provided in the printing material container in a simple manner.

As a second aspect, the present invention provides a printing apparatus that measures the amount of a printing material contained in a printing material container.

A printing apparatus according to another aspect of the invention is a printer which a printing material container is detachably mounted to, the printing material container having a piezoelectric element for detecting the amount of a printing material contained therein, and a memory in which frequency information on vibration frequency of the piezoelectric element that is contained in a response signal outputted from the piezoelectric element in response to a driving signal supplied to the piezoelectric element in a state where the printing material is not present in the printing material container is stored, the printer comprising: an acquiring section that acquires the frequency information from the memory of an printing material container that is a detection target; a storing section that pre-stores vibration frequency range information that associates each of a plurality of vibration frequency ranges with a corresponding driving signal frequency information that specifies the frequency of the driving signal, the plurality of vibration frequency ranges being divided out of the natural vibration frequency range within which the natural vibration frequency could fall; a selecting section that selects, among the plurality of vibration frequency ranges, a vibration frequency range which the vibration frequency specified by the frequency information falls within; a supplying section that supplies the driving signal to the piezoelectric element of the printing material container at the frequency of the driving signal that is specified by the driving signal frequency information associated with the vibration frequency range; a detecting section that detects the response signal that is outputted from the piezoelectric element after the stopping of supply of the driving signal; a measuring section that measures vibration frequency of the piezoelectric element contained in the response signal; and a determining section that determines whether the printing material is present in the printing material container or not based on the vibration frequency, wherein the frequency of the driving signal is a value obtained by multiplying a certain frequency by 1/(2k+1) (where “k” denotes any arbitrary integer of 1 or greater), the certain frequency being lower than the maximum frequency in each of the vibration frequency range by a fixed percentage.

With a printing apparatus according to an aspect of the invention, it is possible to associate the frequency of a driving signal with each vibration frequency range in advance; and therefore, just with a simple system configuration, it is further possible to supply a driving signal to a piezoelectric element at a driving signal frequency that is suitable for a printing material container at the time of detecting the remaining amount of a printing material contained in the printing material container. Therefore, when a printing apparatus according to an aspect of the invention is employed, it is possible to improve the precision in detection of the amount of a printing material.

In the present invention, various aspects and embodiments described above may be combined and/or partly omitted for implementation. In addition to the implementation as a printing apparatus as described above, the present invention may also be implemented as a method for detecting a printing material by means of a printing apparatus, a computer program for dictating a printing apparatus to detect the remaining amount of a printing material, a computer-readable storage medium that stores such a computer program, and so on. In any of the implementations enumerated above, it is possible to apply each aspect and embodiment enumerated above in a suitable manner. As a computer-readable storage medium, it is possible to adopt a variety of medium, including but not limited to, a flexible disc, CD-ROM, DVD-ROM, magnetic optical disc, IC card, or hard disk.

### BRIEF DESCRIPTION OF THE DRAWINGS

The invention will be described with reference to the accompanying drawings, wherein like numbers reference like elements:

FIG. 1 is an explanatory drawing that schematically illustrates an example configuration of a printing system according to a first embodiment of the invention;

FIG. 2 is an explanatory drawing that schematically illustrates an example configuration of a print head unit according to the first embodiment of the invention;

FIG. 3 is an explanatory drawing that schematically illustrates an example electric configuration of a main control unit according to the first embodiment of the invention;

FIG. 4 is an explanatory drawing that schematically illustrates an example electric configuration of a sub control unit and cartridges according to the first embodiment of the invention;

FIGS. 5A and 5B is a set of explanatory drawings that exemplify the configuration of an ink cartridge according to the first embodiment of the invention;

FIGS. 6A and 6B is a set of sectional diagrams that exemplify the configuration of the sensor peripheral part according to the first embodiment of the invention;

FIG. 7 is an explanatory drawing that exemplifies the waveform of the natural vibration of a piezoelectric element according to the first embodiment of the invention;

FIGS. 8A and 8B is a set of explanatory drawings that exemplify the error range of the natural vibration frequency of a cartridge according to the first embodiment of the invention;

FIG. 9 is an explanatory drawing that exemplifies a detectable range according to the first embodiment of the invention;

FIG. 10 is a flowchart illustrating an ink amount determination processing according to the first embodiment of the invention;

FIG. 11 is a waveform diagram that explains the generation of a driving signal according to the first embodiment of the invention;

FIG. 12 is a timing chart illustrating a frequency measurement processing according to the first embodiment of the invention;

FIG. 13 is an explanatory drawing that exemplifies the internal configuration of a main control unit according to a second embodiment of the invention; and

FIG. 14 is an explanatory drawing that exemplifies a frequency table according to the second embodiment of the invention.

### DESCRIPTION OF EXEMPLARY EMBODIMENTS

With reference to accompanying drawings, mode for carrying out the invention is described below while discussing exemplary embodiments.

### A. Exemplary Embodiment 1

### A1. System Configuration

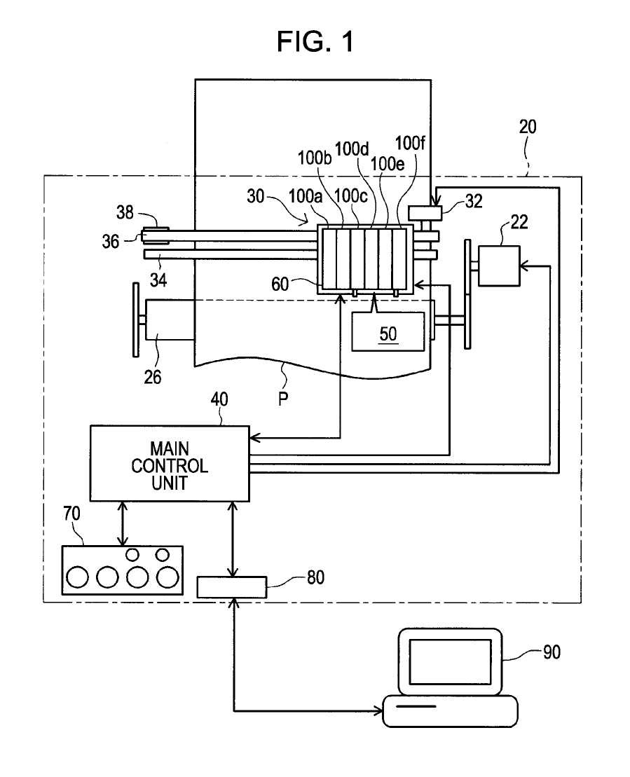

The outline of a printing system configuration according to the first exemplary embodiment is explained with reference to FIG. 1. FIG. 1 illustrates the general configuration of a printing system. The printing system comprises a printer 20 and a computer 90. The printer 20 is connected to the computer 90 via a connector 80.

The printer 20 is provided with a sub scan feed mechanism, a main scan feed mechanism, a head control mechanism, and a main controlling unit 40 that controls each mechanism. The sub scan feed mechanism is provided with a paper feed motor 22 and a platen 26. The sub scan feed mechanism transports a paper P in the sub scan direction by communicating the rotational force of the paper feed motor 22. The main scan feed mechanism is provided with a carriage motor 32, a pulley 38, a driving belt 36 which is stretched between the carriage motor 32 and the pulley 38, and a sliding axis 34 which is provided in parallel with the axis of the platen 26. The sliding axis 34 supports the carriage 30 that is fixed to the driving belt 36 in a sliding manner. The rotation of the carriage motor 32 is communicated to the carriage 30 via the driving belt 36. The carriage 30 reciprocates in the axial direction (main scan direction) of the platen 26 along the sliding axis 34. The head control mechanism is provided with a print head unit 60 that is mounted on the carriage 30. By driving the print head, the head control mechanism causes ink to be discharged on the paper P. The printer 20 is further provided with a manipulation unit 70 that is used for various printer settings manipulated by a user and for printer status verification.

The print head unit 60 is provided with a print head and a cartridge attachment unit. To the cartridge attachment unit, six ink cartridges 100a-100f are attached. The print head unit 60 is further provided with a sub control section 50.

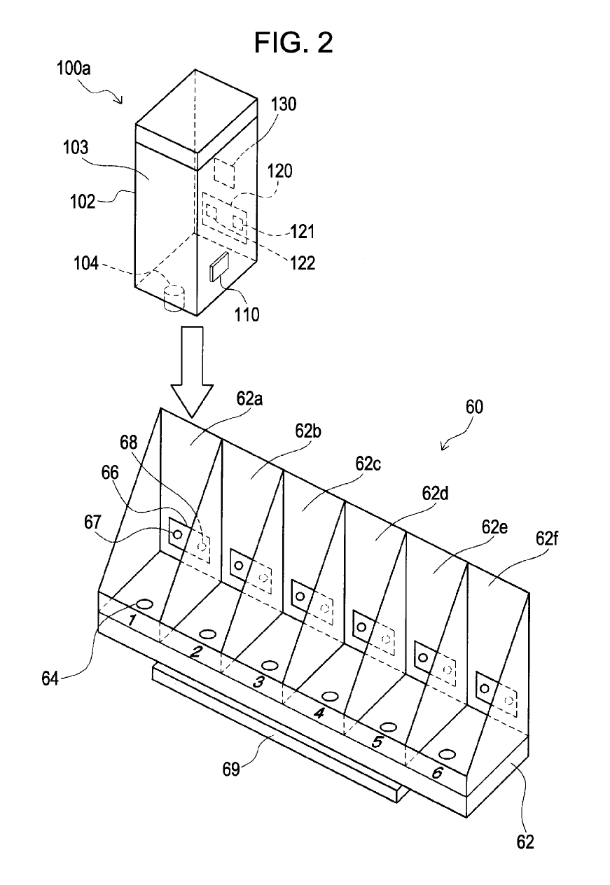

The configuration of the print head unit 60 and the outline configuration of ink cartridges are explained with reference to FIG. 2. FIG. 2 illustrates the general configuration of a print head unit 60. As illustrated in FIG. 2, the print head unit 60 is provided with a cartridge attachment unit 62, to which ink cartridges 100a-100f are attached, and a print head 69. In addition, the print head unit 60 is provided with a sub control unit 50 shown in FIG. 1 (not shown in FIG. 2).

In the following description, explanation on the cartridges 100b-100f is omitted while exemplifying the cartridge 100a only because the configurations of the cartridges 100b-100f are the same as that of the cartridge 100a. As illustrated in FIG. 2, the ink cartridge (in this embodiment, hereafter, simply referred to as “cartridge”) 100a has a body 102, an ink supply port 104 that is provided at the bottom of the body 102, a sensor 110 that is provided at the lower side of one side surface of the body 102, and a terminal assembly 120 and a memory 130, both of which are provided on another side surface of the body 102.

The body 102 has an ink container room 103 for containing ink inside. Ink drains through the ink supply port 104. The sensor 110 is provided with two electrodes, whereas the terminal assembly 120 has two terminals 121 and 122, which are connected to two electrodes provided on the sensor 110, respectively.

In the memory 130 of the cartridge 100a, frequency information 135, which is used for determining the amount of ink contained in the ink cartridge 100a, is stored. The frequency information 135 indicates the frequency of a driving signal for driving the piezoelectric element 112 of the cartridge 100a, where the frequency information 135 is written into the memory 130 at the time of production of the cartridge 100a. The frequency information 135 will be discussed later.

The cartridge attachment unit 62 is provided with separate attachment units 62a-62f, which respective cartridges are attached to. Each of the separate attachment units 62a-62f has an ink introduction part 64 and a terminal assembly 66. For example, when the ink cartridge 100a is attached to the separate attachment unit 62a, the ink supply port 104 of the cartridge 100a is inserted in the ink introduction part 64 so as to provide a passage for ink to the print head 69 of the separate attachment unit 62a. In addition, when the ink cartridge 100a is attached to the separate attachment unit 62a, two of the terminals 67 and 68 of the terminal assembly 66 of the separate attachment unit 62a are electrically connected to two of the terminals 121 and 122 of the terminal assembly 120 provided on the cartridge 100a. Two of the terminals 67 and 68 of the terminal assembly 66 of each of the separate attachment units 62a-62f are electrically connected to the sub control unit 50. That is, the sub control unit 50 is electrically connected to the sensor 110 of each of the cartridges 100a-100f via two of the terminal assemblies 66 and 120.

Having a plurality of nozzles and a plurality of piezoelectric elements, the print head 69 discharges ink drops from each nozzle to configure dots on the paper P depending on a voltage applied to each piezoelectric element. In the embodiments and the preceding part of description in this specification as well as the recitation of appended claims, a “piezoelectric element” (called as “atsuden soshi” in Japanese) refers to a device having a piezoelectric effect, which may also be defined as a piezoelectric-effect element. In this embodiment, although a “piezo-device” (called as “piezo soshi” in Japanese) is employed as a specific example of such an element, it is simply referred to as a piezoelectric element without differentiating specific concept from generic one for an easier explanation.

### A2. Printer Circuit Configuration

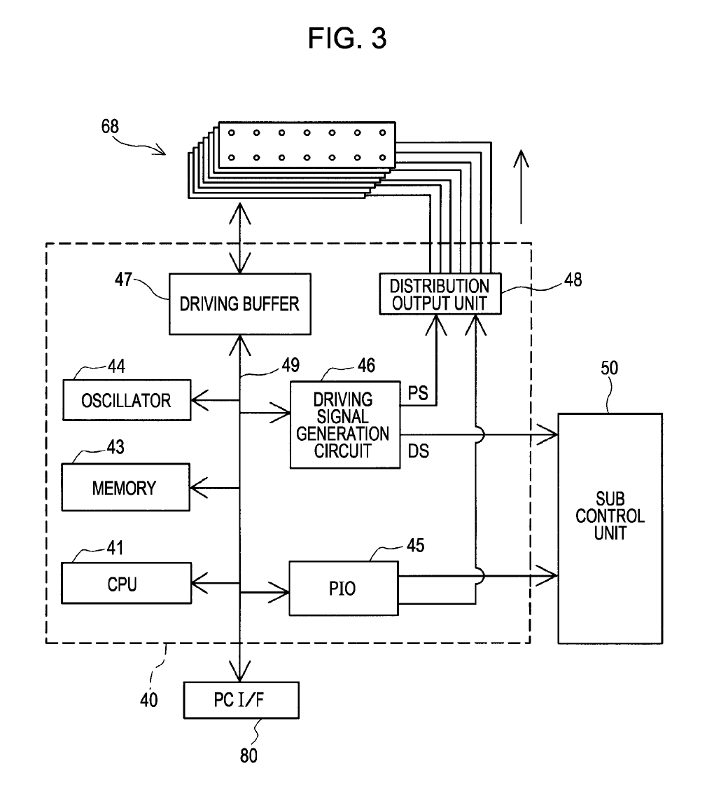

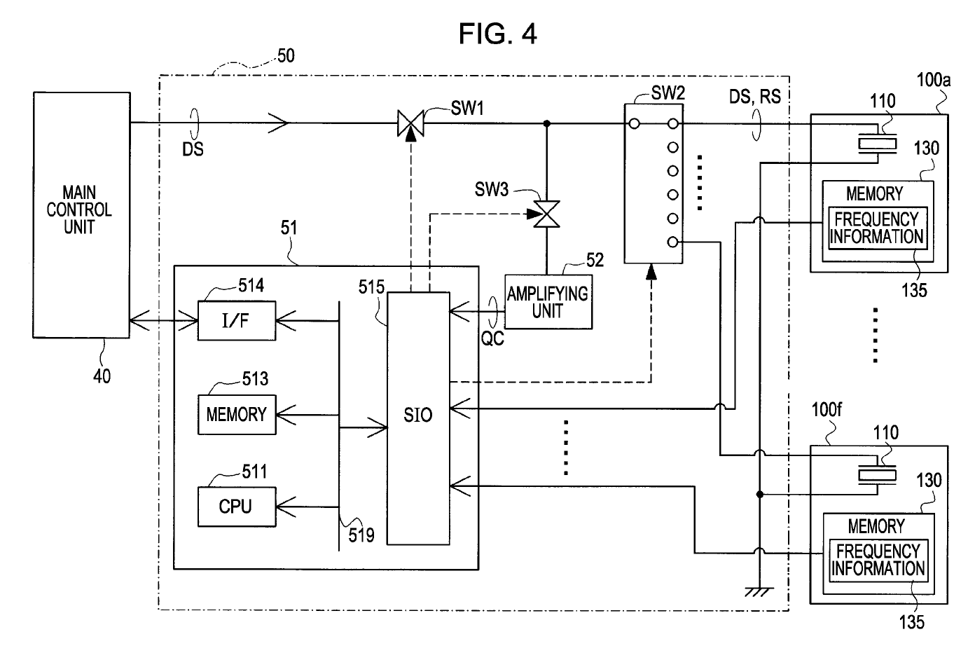

The circuit configuration of the printer 20 is explained with reference to FIG. 3 and FIG. 4. FIG. 3 illustrates the electric configuration of the main control unit 40 according to the present embodiment of the invention. FIG. 4 illustrates the electric configuration of the sub control unit 50 and the cartridge 100a according to this embodiment of the invention.

The main control unit 40 is provided with a CPU 41, a memory 43, an oscillator 44 that generates a clock signal, a peripheral device input output unit (PIO) 45 that provides/receives a signal to/from a peripheral device, a driving signal generation circuit 46, a driving buffer 47, and a distribution output unit (splitter) 48. These components are interconnected with each other via a bus 49. The bus 49 is also connected to the connector 80, and the main control unit 40 is connected to the computer 90 via the bus 49 and the connector 80. With these connections, it is possible for each of the components described above to provide/receive data to/from other components.

The driving buffer 47 is used as a buffer that supplies a dot ON/OFF signal to the print head 69. The distribution output unit 48 distributes a driving signal that is supplied from the driving signal generation circuit 46 to the print head 69 at a predetermined timing.

The driving signal generation circuit 46 generates a head driving signal PS, which is supplied to the print head 69 via the distribution output unit 48, and a sensor driving signal DS, which is supplied to the piezoelectric element 112 of each of the cartridges 100a-100f via the sub control unit 50. In this embodiment, hereafter, a “driving signal” signifies a sensor driving signal. The driving signal generation circuit 46 supplies the generated driving signal DS to the sensor 110 via the sub control unit 50.

More specifically, the driving signal generation circuit 46 is provided with a computing unit, a digital/analog conversion unit (D/A converter), and an amplifying circuit, all of which are not shown in the drawing. The computing unit generates a digital signal that indicates the waveform of a voltage that should be generated by using voltage waveform data. The digital/analog conversion unit converts the generated digital signal into an analog signal. The amplifying circuit amplifies the analog signal so as to generate a driving signal having a desired waveform.

The sub control unit 50 is a circuit that performs processing which is related to the cartridges 100a-100f in cooperation with the main control unit 40. Among processing related to the cartridges 100a-100f, FIG. 4 shows, in a selective manner, portions that are necessary for processing of determining the amount of ink. As shown in FIG. 4, the sub control unit 50 is provided with a calculator 51, three switches SW1-SW3, and an amplifying unit 52.

The calculator 51 is provided with a CPU 511, a memory 513, an interface 514, and an input/output unit (SIO) 515, which functions to provide/receive a signal to/from the components inside the sub control unit 50 and to/from the cartridges 100a-100f. Each of the aforementioned components of the main control unit 40 is connected thereto via the bus 519. The calculator 51 provides/receives a signal to/from the main control unit 40 via the interface 514. The calculator 51 controls the three switches SW1-SW3 via the SIO 515. In addition, the calculator 51 receives output from the amplifying unit 52 via the SIO 515. Furthermore, the calculator 51 acquires, from the memory 130 of the cartridges 100a-100f that are attached to the cartridge attachment unit 62 via the SIO 515, the frequency information stored in the memory 130.

The first switch SW1 is a 1-channel analog first switch. One terminal of the first switch SW1 is connected to the driving signal generation circuit 46 of the main control unit 40, whereas the other terminal thereof is connected to the second switch SW2 and the third switch SW3. The first switch SW1 is set in an ON state when the driving signal DS is supplied to the sensor 110, whereas it is set in an OFF state when a response signal RS coming from the sensor 110 is detected.

The second switch SW2 is a 6-channel analog first switch. One terminal of the second switch SW2 at one side is connected to the first switch SW1 and the third switch SW3, whereas each of six terminals at the other side thereof is connected to one electrode of the corresponding sensor 110 of the corresponding six cartridge 100a-100f. It should be noted that the other electrode of each sensor 110 is grounded. By switching the second switch SW2 over in a sequential manner, either one of the six cartridges 100a-100f is selected sequentially.

The third switch SW3 is a 1-channel analog first switch. One terminal of the third switch SW3 is connected the first switch SW1 and the second switch SW2, whereas the other terminal is connected to the amplifying unit 52. The third switch SW3 is set in an OFF state when the driving signal DS is supplied to the sensor 110, whereas it is set in an ON state when a response signal RS coming from the sensor 110 is detected.

The amplifying unit 52, which includes an operational amplifier, compares the response signal RS with a reference voltage Vref to function as a comparator, where the amplifying unit 52 outputs a HIGH signal when the voltage of the response signal RS is equal to or greater than the reference voltage Vref whereas it outputs a LOW signal when the voltage of the response signal RS is less than the reference voltage Vref. The output signal QC coming from the amplifying unit 52 takes the form of a digital signal that consists of a HIGH signal and a LOW signal only.

The CPU 41 counts the output signal QC that is outputted from the amplifying unit 52 so as to measure the frequency of the piezoelectric element 112, and then, based on the measured frequency, it determines the amount of ink contained in the ink cartridge. As for determination processing of ink amount, an explanation will be given later.

### A3. Detailed Configuration of Ink Cartridge and Sensor

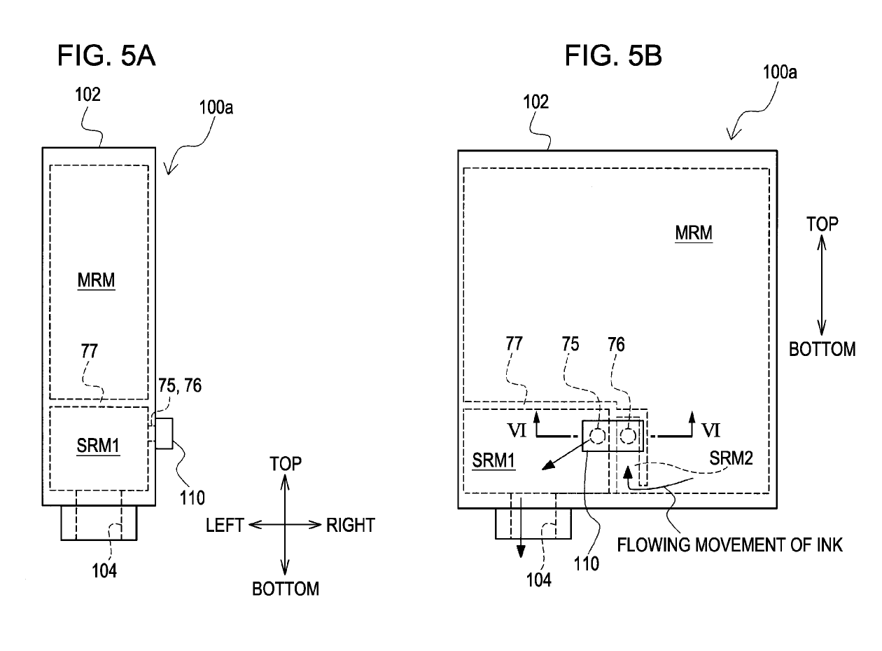

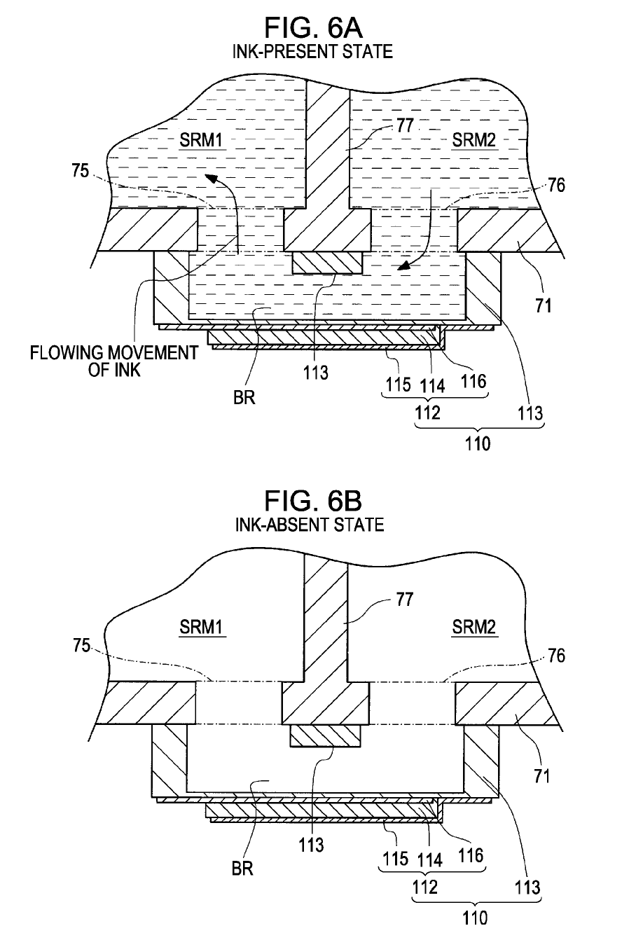

The detailed configuration of the ink cartridge and the sensor is explained with reference to FIG. 5 and FIG. 6. FIG. 5 include a front view (FIG. 5A) and a side view (FIG. 5B) that exemplify the configuration of an ink cartridge. FIG. 6A and FIG. 6B are sectional views of the peripheral part of the sensor provided in the ink cartridge.

As illustrated in FIG. 5A and FIG. 5B, the body 102 of the cartridge 100a has a plurality of container rooms in which ink is contained. A main container room MRM occupies the majority of the entire volume of the container rooms. A first sub container room SRM1 is in communication with an ink supply port 104 at the bottom surface. A second sub container room SRM2 is in communication with the main container room MRM in the neighborhood of the bottom surface.

FIG. 6A and FIG. 6B illustrate the cross section of the sensor peripheral part cut along an A-A line of FIG. 5B, where the cross section is viewed from the top. As illustrated in FIG. 6A and FIG. 6B, the sensor 110 is provided with the piezoelectric element 112 and a sensor attachment 113. The piezoelectric element 112, which has a piezoelectric unit 114 as well as two electrodes 115 and 116 that sandwich the piezoelectric unit 114, is provided on the sensor attachment 113. The piezoelectric unit 114 is formed of ferroelectric such as Pb (ZrₓTi₁₋ₓ) O₃ (PZT). In the sensor attachment 113, a bridge fluid channel BR is formed roughly in a letter “U” shape, or a little more exactly, in the shape of a lower half of 90′-turned square brackets (roughly in the shape of letter “ko” in Japanese “katakana” character). The part of the sensor attachment 113 between the bridge fluid channel BR and the piezoelectric element 112 is shaped to form a thin film. With such a configuration, the peripheral part of the piezoelectric element 112, inclusive of the bridge fluid channel BR, vibrates together with the piezoelectric element 112 itself.

The ink contained in the cartridge 100a flows as illustrated by solid arrows in FIG. 5A, FIG. 5B, FIG. 6A, and FIG. 6B. More specifically, the ink contained in the main container room MRM flows into the second sub container room SRM2 through the neighborhood of the bottom surface. The ink that has flowed into the second sub container room SRM2 passes through a second side surface hole 76, the bridge fluid channel BR in the sensor attachment 113, a first side surface hole 75, and then flows into the first sub container room SRM1. Finally, the ink that has flowed into the first sub container room SRM1 passes through the ink supply port 104 to be supplied to the print head unit 60.

FIG. 6A illustrates a state in which, a predetermined amount, or greater, of ink is present in the cartridge 100a (in this embodiment, hereafter, such a state is referred to as “ink-present state”). As illustrated in FIG. 6A, the ink-present state indicates a state in which ink is filled inside the bridge fluid channel BR formed in the sensor attachment 113, which constitutes a part of the sensor 110. In other words, the ink-present state signifies a state in which some ink is present at the position where the sensor 110 is provided in the cartridge 100a (i.e. ink detection position) and which the ink is in contact with the thin film portion of the sensor attachment 113, where the film portion is sandwiched between the bridge fluid channel BR and the piezoelectric element 112.

On the other hand, FIG. 6B illustrates a state in which the amount of ink that is present in the cartridge 100a is less than a predetermined amount (in this embodiment, hereafter, such a state is referred to as “ink-absent state”). The ink-absent state indicates a state in which ink is not filled inside the bridge fluid channel BR. In other words, the ink-absent state signifies a state in which no ink is present at the ink detection position and which no ink is in contact with the ink detection area.

### A4. Operation of Piezoelectric Element

The operation of the piezoelectric element 112 is described here. When a driving signal is supplied from the printer 20 to the piezoelectric element 112 provided in the cartridge 100a to apply a voltage thereto, the piezoelectric element 112 expands and contracts. When the supply of the driving signal to the piezoelectric element 112 is stopped so as to further stop the application of the voltage, the piezoelectric element 112 vibrates (starts residual vibration) in accordance with expansion and contraction that had occurred prior to the stopping of the driving signal.

From the piezoelectric element 112, a response signal in response to the residual vibration is outputted. The frequency of the response signal takes the same value as that of the natural vibration frequency (eigenfrequency) of the residual vibration of the piezoelectric element 112. The natural vibration frequency of the residual vibration of the piezoelectric element 112 varies greatly depending on whether some ink is in contact with the ink detection area or not. In other words, the natural vibration frequency of the piezoelectric element 112 in an ink-present state differs from that in an ink-absent state. More specifically, the natural vibration frequency H1 of the piezoelectric element 112 in an ink-present state is slow (low), whereas the natural vibration frequency H2 of the piezoelectric element 112 in an ink-absent state is quick (high). Therefore, measuring the frequency of the response signal in response to the residual vibration of the piezoelectric element 112, the printer 20 judges as to whether the amount of ink remaining is greater than, or at least equal to, a predetermined amount thereof, where such a judgment depends on whether the measured frequency is closer to the natural vibration frequency H1 or H2. In this embodiment, hereafter, the frequency of the response signal in response to the residual vibration of the piezoelectric element 112 is referred to as vibration frequency.

### A5. Driving Signal Frequency and Vibration Frequency

A driving signal for improving the precision in detection of a vibration frequency is explained here. As described above, the printer 20 supplies a driving signal to a piezoelectric element that is provided in a cartridge, and measures the frequency of a response signal that is outputted from the sensor so as to determine the amount of ink contained in the cartridge. For this purpose, it is desirable to make the amplitude of a response signal larger in order to improve the detection precision of the vibration frequency of the response signal. Therefore, it is preferable that the frequency of a driving signal is matched with the natural vibration frequency of the sensor for the purpose of improving the detection precision of the vibration frequency of the response signal. This is because a piezoelectric element resonates so as to output a response signal having a relatively larger amplitude when a driving signal having the same frequency as that of the natural vibration frequency of the sensor is supplied to the piezoelectric element.

As related art, the printer 20 supplies a driving signal having the same frequency as the natural vibration frequency H2 in an ink-absent state to the sensor 110 so as to determine whether the amount of ink contained in the cartridge is less than a predetermined amount or not, and then supplies another driving signal having the same frequency as the natural vibration frequency H1 in an ink-present state to the sensor 110 so as to determine whether the amount of ink contained in the cartridge is greater than, or at least equal to, the predetermined amount or not, which means that determination processing is conducted twice. In such an operation, there is a problem in that it takes a relatively longer time for determination.

In order to address such a problem, the cartridge configuration is adjusted so that the natural vibration frequency H1 and the natural vibration frequency H2 satisfy the relation defined by the following Mathematical Expression 1.

H2=(2k+1)*H1 (where “k” denotes an integer of 1 or greater) (Mathematical Expression 1)

For the purpose of satisfying the above relation between the natural vibration frequency H1 and the natural vibration frequency H2 defined by the Mathematical Expression 1, during a production process of cartridges, for example, the form of the bridge fluid channel BR of a cartridge and the stiffness of the sensor attachment 113 thereof are adjusted.

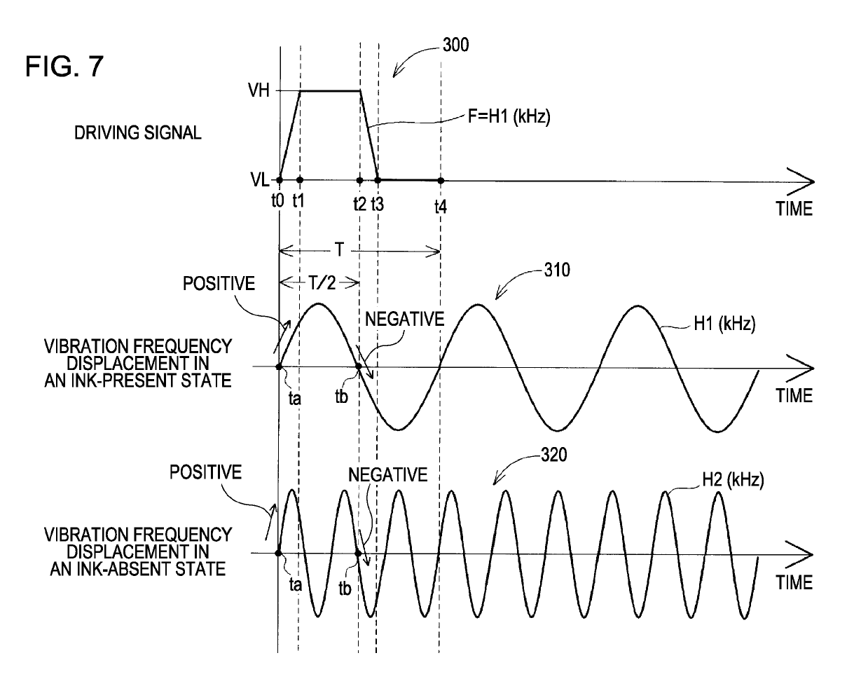

With the above configuration, it is possible to effectively excite the amplitude of residual vibration both in an ink-present state and an ink-absent state just with one type of a driving signal, which makes it further possible to determine the amount of ink just with one execution of determination processing while maintaining the precision in detection. This reason is explained with reference to FIG. 7. FIG. 7 is an explanatory drawing that exemplifies the waveform of the natural vibration of an piezoelectric element according to this embodiment of the invention. FIG. 7 illustrates the pulse waveform 300 of a driving signal, the natural vibration waveform 310 of a piezoelectric element in an ink-present state (natural vibration frequency H1), and the natural vibration waveform 320 of the piezoelectric element in an ink-absent state (natural vibration frequency H2). In the following description, with respect to the displacement direction of the piezoelectric element 112, it is assumed that the direction from the piezoelectric element 112 to the inner side of the cartridge is a positive direction, while the direction from the piezoelectric element 112 to the outer side of the cartridge is a negative direction. It should be noted that, in this figure, k=1 is assumed in the Mathematical Expression 1.

As represented by the pulse waveform 300, a driving signal that is supplied to the piezoelectric element takes the form of a rectangular pulse having an approximately trapezoidal shape. During a period in which the part of the pulse waveform 300 slants in the rising direction from the minimum voltage VL to the maximum voltage VH, that is, during a charge period t0-t1 in which electric charge is accumulated in the piezoelectric element, the piezoelectric element 112 is displaced in a positive direction, which is a direction toward the inner side of the cartridge. During a maximum level period t1-t2 in which the part of the pulse waveform 300 is kept at the level of the maximum voltage VH, the piezoelectric element 112 maintains its positively displaced state without any status change. During a period in which the part of the pulse waveform 300 slants in the falling direction from the maximum voltage VH to the minimum voltage VL, that is, during a discharge period t2-t3 in which electric charge accumulated in the piezoelectric element is discharged, the piezoelectric element 112 is displaced in a negative direction, which is a direction toward the outer side of the cartridge. During a period in which the part of the pulse waveform 300 is kept at the level of the minimum voltage VL, that is, during a non-application period t3-t4 in which no voltage is applied to the piezoelectric element 112, the piezoelectric element 112 maintains its negatively displaced state without any status change. At the point in time t4, the supply of the driving signal DS to the sensor is stopped.

As illustrated in FIG. 7, the piezoelectric element is urged in a vibration direction because the pulse (waveform) 300 starts to rise at a point in time (ta) where the natural vibration (natural vibration frequency H1) of the piezoelectric element in an ink-present state, which is represented by the waveform 310, is displaced with the positive maximum vibration speed (in this embodiment, hereafter, this point in time is referred to as positive maximum speed time “ta”), whereas the piezoelectric element is urged in a vibration direction because the pulse 300 starts to fall at a point in time (tb) where the natural vibration thereof is displaced with the negative maximum vibration speed (in this embodiment, hereafter, this point in time is referred to as negative maximum speed time “tb”). The negative maximum speed time “tb” corresponds to a point in time which is a half cycle after the positive maximum speed time “ta”. Generally, vibration is most effectively excited when it is urged in a vibration direction at a point in time at which the vibration speed is the maximum. For this reason, according to a driving signal that is represented by the pulse waveform 300, the natural vibration of the piezoelectric element at an ink-present state, which is the natural vibration frequency H1, is excited effectively. Therefore, when a driving signal that has the same frequency as the natural vibration frequency is supplied, the residual vibration of the sensor in the ink-present state, which is the natural vibration frequency H1, is excited effectively, which produces an amplitude large enough for detection processing of a response signal RS performed by the printer 20.

On the other hand, as in the same manner as the waveform 310, according to the residual vibration (natural vibration frequency H2) of the sensor in an ink-absent state, which is represented by the waveform 320, it is displaced with the positive maximum vibration speed at the positive maximum speed point in time “ta”, whereas it is displaced with the negative maximum vibration speed at the negative maximum speed point in time “tb”. Therefore, according to a driving signal represented by the pulse waveform 300, the residual vibration of the sensor in an ink-absent state, which is the natural vibration frequency H2, is also excited effectively, which produces an amplitude large enough for detection processing of a response signal RS performed by the printer 20.

As described above, it is possible to determine as to whether a greater than, or at least equal to, a predetermined amount of ink remains or it is less than the predetermined amount thereof just by one execution of detection processing, which is achieved by adjusting the cartridge so that the Mathematical Expression 1 is satisfied.

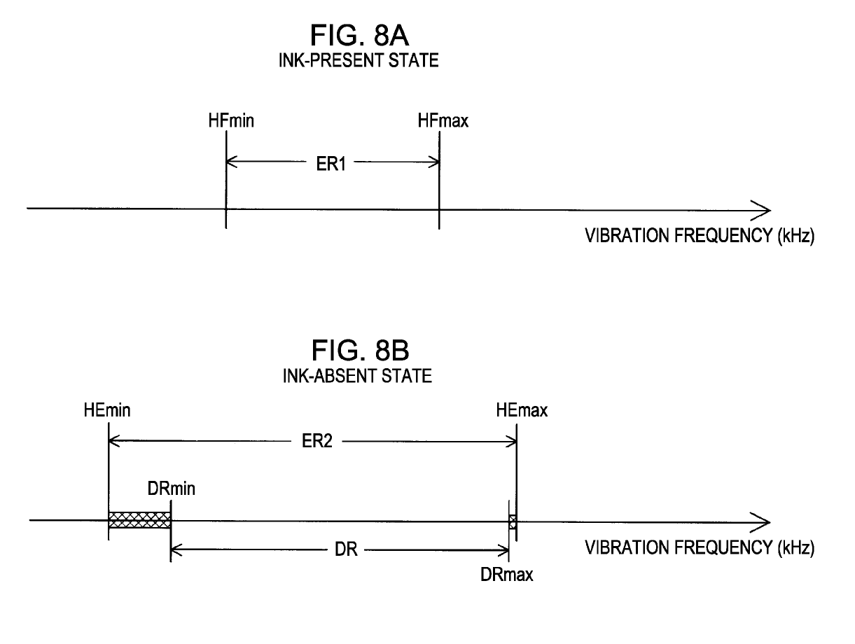

However, because of margin of manufacturing errors that could occur during a production process of a cartridge/sensor, it is difficult to produce a cartridge and a sensor so that the above Mathematical Expression 1 is necessarily satisfied. Therefore, generally speaking, there is a margin of error between the natural vibration frequency H1 and its targeted vibration frequency, and between the natural vibration frequency H2 and its targeted vibration frequency. This margin of error is explained with reference to FIG. 8. FIG. 8 is an explanatory set of drawings that exemplify the error range of the natural vibration frequency of a cartridge according to the embodiment of the invention. FIG. 8A indicates the error range of the natural vibration frequency of a sensor in an ink-present state, while FIG. 8B indicates the error range of the natural vibration frequency of the sensor in an ink-absent state.

As illustrated in FIG. 8A, the error range ER1 of the natural vibration frequency HF of a sensor in an ink-present state is denoted as “from HFmin (kHz) to HFmax (kHz)”. On the other hand, as illustrated in FIG. 8B, the error range ER2 of the natural vibration frequency HE of the sensor in an ink-absent state is denoted as “from HEmin (kHz) to HEmax (kHz)”.

The frequency of a response signal in an ink-absent state, with the natural vibration frequency HF being set as the frequency of a driving signal, is explained below. When a driving signal having the frequency of the same value as the natural vibration frequency HF is supplied to the piezoelectric element, a satisfactory precision is expected if the natural vibration frequency HE of the sensor of the target cartridge in an ink-absent state falls within the range specified by the following Mathematical Expression 2. In this embodiment, hereafter, the range defined by the Mathematical Expression 2 is referred to as detectable range DR.

(Driving Signal Frequency F*3)−α%≦Natural Vibration Frequency HE≦(Driving Signal Frequency F*3)+α% (Mathematical Expression 2)

In the Mathematical Expression 2, when α=0, in other words, when the driving signal frequency F*3=the natural vibration frequency HE, the natural vibration frequency HE is an odd number multiple of the driving frequency F; and in such a condition, the residual vibration of the sensor of the target cartridge in an ink-absent state is most effectively excited. The numerical value α in the Mathematical Expression 2 denotes an error tolerance factor that is calculated based on a production test conducted during a production process, where the value thereof in this embodiment is α=8.

If the natural vibration frequency HE of the target cartridge falls within the detectable range DR (from DRmin (kHz) to DRmax (kHz)), the residual vibration of the sensor is excited effectively so as to amplify the amplitude of a response signal. However, when the natural vibration frequency HE of the target cartridge is less than the detectable minimum vibration frequency DRmin (kHz) (i.e. when it falls within the hatched area in FIG. 8B), the residual vibration of the sensor is not effectively excited, which deteriorates the precision in detecting a response signal.

On the other hand, an explanation is given below on the precision in detecting a response signal in an ink-present state when the frequency of a driving signal is set while using the natural vibration frequency HE as its referential basis. When a driving signal having the driving signal frequency F is supplied to a piezoelectric element, if the natural vibration frequency HF of the target cartridge in an ink-present state falls within the range of “driving signal frequency F±25%”, the residual vibration of the sensor is excited effectively. However, when the natural vibration frequency HE of the target cartridge is less than the “driving signal frequency F−25%” (i.e. when it falls within the hatched area in FIG. 8A), the residual vibration of the sensor is not effectively excited, which deteriorates the precision in detecting a response signal. Herein, as mentioned earlier, the error range ER1 of the natural vibration frequency HF in an ink-present state is denoted as “from HFmin (kHz) to HFmax (kHz)”, whereas the error range ER2 of the natural vibration frequency HE in an ink-absent state is denoted as “from HEmin (kHz) to HEmax (kHz)”, where, while using the Mathematical Expression 3, it is possible to calculate the natural vibration frequency HF by measuring the natural vibration frequency HE in an ink-absent state through a test conducted during a production process.

fF=(fE−HEmin)*(HFmax−HFmin)/(HEmax−HEmin)+HFmin (Mathematical Expression 3)

When the natural vibration frequency HF in an ink-present state calculated from the above Mathematical Expression 3 falls within the range of “driving signal frequency F±25%”, the residual vibration of the piezoelectric element in an ink-absent state is excited effectively.

Herein, although the natural vibration frequency HF in an ink-absent state of the piezoelectric element 112 can be calculated through a production test, in practical implementation, there is a problem of possible lower vibration, that is, vibration lower than the natural vibration frequency HE when the cartridge experiences an ink-absent state because of some ink affixed to the surface of the wall of the bridge fluid channel BR at the sensor 110 side.

In order to address such a problem, according to the invention, the frequency of a driving signal is calculated as a numerical value that is obtained by multiplying (2k+1) by a vibration frequency that is lower than the natural vibration frequency in an ink-absent state, HE, for each cartridge by a fixed percentage (β %). In this embodiment of the invention, the frequency information 135 that specifies the calculated driving signal frequency is pre-stored in the memory 130 of each cartridge. The calculation of a driving signal frequency according to the invention is explained below. It should be noted that, preferably, the value of β should be equal to, or a little less than, the value of α. This is because, if it is greater than α, a response signal in an ink-present state is not excited effectively. In this embodiment of the invention, it is assumed as β%=7%. The value of β is determined based on the result of a production test.

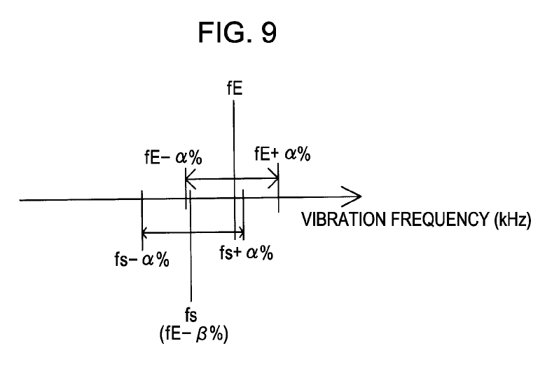

As illustrated in FIG. 9, the driving signal frequency F is calculated while taking a vibration frequency that is lower than the natural vibration frequency HE in an ink-absent state of the target cartridge by β % as a reference basis (in this embodiment, hereafter, such a lower frequency is referred to as reference vibration frequency “fs”). More specifically, the numerical value obtained by multiplying the reference vibration frequency “fs” by 1/(2k+1) is used as the driving signal frequency F. The relation between the natural vibration frequency HE and the driving signal frequency F is defined as the following Mathematical Expression 4. In this embodiment of the invention, the function “round (x)” is a function that provides a value rounded to one decimal place.

Driving Signal Frequency F=round [(natural vibration frequency HE−β%)*(1/(2k+1))] (Mathematical Expression 4)

In this embodiment of the invention, it is assumed as k=1, and reference vibration frequency fs=natural vibration frequency HE−β %, the driving signal frequency F is expressed as the mathematical formula 5.

Driving Signal Frequency F=round [reference frequency fs*(⅓)] (Mathematical Expression 5)

As described above, according to this embodiment of the invention, the driving signal frequency is set at a frequency having the same value as a certain vibration frequency multiplied by 1/(2k+1), where the above certain vibration frequency is lower than the natural vibration frequency of the target cartridge by a fixed percentage; and having such a configuration, the invention makes it possible to effectively excite the amplitude of a response signal both in an ink-present state and in an ink-absent state.

### A6. Ink Amount Determination Processing

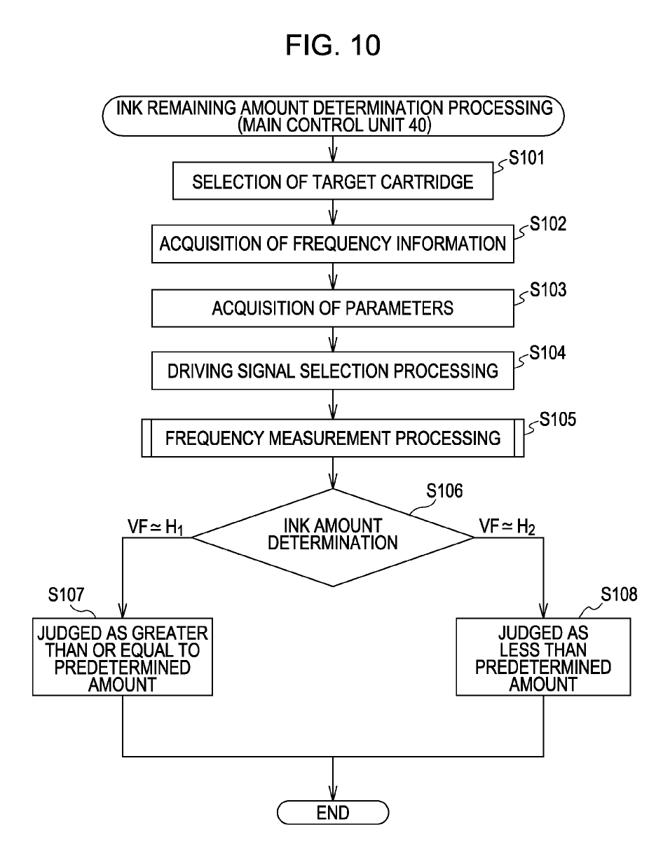

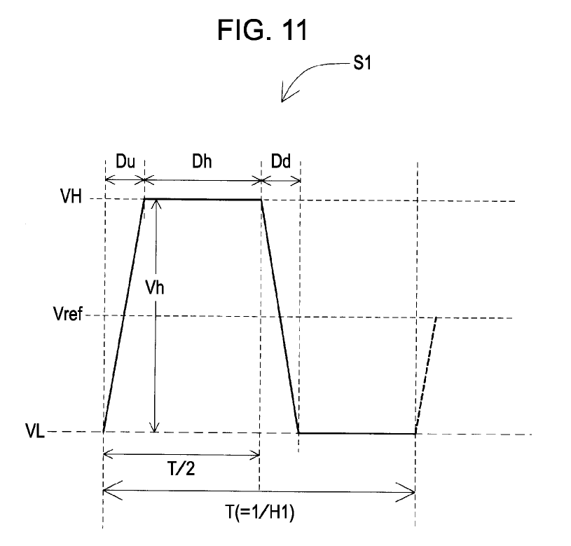

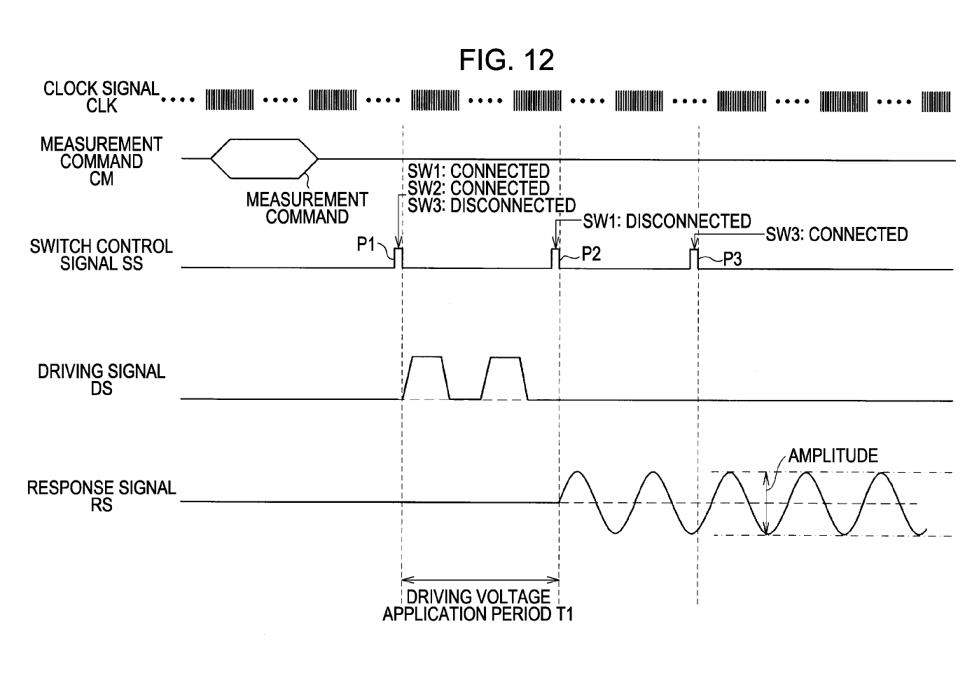

Ink amount determination processing, which is executed by the main control unit 40 and the sub control unit 50, functioning in cooperation with each other, of the printer 20 is explained with reference to FIG. 10 through FIG. 12. FIG. 10 is a flowchart for explaining ink amount determination processing according to this embodiment of the invention. FIG. 11 is a waveform diagram that explains the generation of a driving signal according to this embodiment of the invention. FIG. 12 is a timing chart for explaining frequency measurement processing according to this embodiment of the invention.

The ink amount determination processing is the determination of amount of ink contained in a cartridge, where such a determination is conducted for each cartridge so as to judge whether the amount of contained ink is greater than, or at least equal to, a predetermined amount thereof, or it is less than the predetermined amount thereof. The ink amount determination processing is executed, for example, at the time of power activation of the printer 20.

Upon starting the ink amount determination processing, the CPU 41 of the main control unit 40 selects a target cartridge, which is subjected to the ink amount determination processing, among the six cartridges 100a-100f (step S101). In this embodiment of the invention, it is assumed that the cartridge 100a is selected as a target cartridge (hereafter, the cartridge 100a is referred to as the target cartridge 100a).

The main control unit 40 acquires the frequency information 135, which specifies a driving signal frequency for driving the piezoelectric element 112 provided in the target cartridge 100a (step S102). More specifically, the main control unit 40 transmits, to the calculator 51 of the sub control unit 50, a command that dictates the sub control unit 50 to acquire the frequency information 135 that is stored in the memory 130 of the target cartridge 100a. In accordance with the command, the CPU 511 of the calculator 51 acquires the frequency information 135 to send it to the sub control unit 50.

The main control unit 40 acquires various parameters other than the frequency information 135 for generation of a driving signal from the memory 43 (step S103). The main control unit 40 generates a driving signal by using the acquired parameters including the frequency information 135 (step S104).

With reference to FIG. 11, the generation of a driving signal is explained below in detail. Firstly, based on the acquired parameters for generation of a driving signal, the CPU 41 calculates the output voltage for each update cycle τ. The update cycle τ ranges, for example, from 0.1 μs (clock frequency=10 MHz) to 0.05 kHz (clock frequency=20 kHz). Taking the partial pulse waveform S1 illustrated in FIG. 11 as an example, parameters contain a driving voltage Vh, a ratio specifying the relation between the driving voltage Vh and the reference voltage Vref, a duration ratio Dua in which the voltage is raised from the minimum voltage to the maximum voltage at a certain inclination, a duration ratio Dha in which the maximum voltage is kept, a duration ratio Dda in which the voltage is lowered from the maximum voltage to the minimum voltage at a certain inclination, and the cycle T of the driving signal. The duration ratio Dha and the duration ratio Dda are set based on the duration ratio Dua as reference.

The cycle T equals to 1/driving signal frequency F, and it is calculated based on the driving signal frequency F specified by the frequency information 135 stored in the memory 130. Among the various parameters described above, all parameters except the cycle T are pre-stored in the memory 43. It should be noted that the reference voltage Vref specifies a reference deformation state in a piezoelectric device (“piezo soshi” in Japanese), which is a piezoelectric element (“atsuden soshi” in Japanese) 112. In this embodiment, the reference voltage Vref is set at 40% of the driving voltage Vh; and therefore, the value of “0.4” is stored in the memory 43 as the ratio specifying the relation between the driving voltage Vh and the reference voltage Vref. In addition, the ratio of “Dua:Dha:Dda” equals to “1:9:1”.

The CPU 41 acquires the frequency information 135 from the memory 130 of the cartridge 100a, which is the target of detection, via the sub control unit 50, and acquires parameters other than the cycle T from the memory 43. Using the frequency information 135 and the duration ratios Dua, Dha, and Dda contained in the acquired parameters, the CPU 41 calculates the duration of time Du during which the voltage is raised from the minimum voltage to the maximum voltage at a certain inclination, the duration of time Dh during which the maximum voltage is kept, and the duration of time Dd during which the voltage is lowered from the maximum voltage to the minimum voltage at a certain inclination. Herein, in this embodiment of the invention, the CPU 41 calculates each of the durations of time Du-Dd so as to satisfy the condition that the sum of the duration of time Du during which the voltage is raised from the minimum voltage to the maximum voltage at a certain inclination and the duration of time Dh during which the maximum voltage is kept equals to the half of the cycle T.

Next, the CPU 41 calculates the reference voltage Vref and the maximum voltage VH based on the parameters stored in the memory 43. Using the durations of time Du-Da described above, the CPU 41 calculates the output voltage for each update cycle τ. Then, the CPU 41 calculates a DAC value for each update cycle τ based on the calculated output voltage for each update cycle τ. The DAC value indicates information that is used for generation of a driving signal, where the DAC information is used for instructing a voltage that should be outputted for each update cycle τ to the driving signal generation circuit 46.

The CPU 41 instructs, to the driving signal generation circuit 46, a voltage that should be outputted by means of the various parameters described above, the duration of times Du-Dd, and the DAC value. In response to the instruction from the CPU 41, the driving signal generation circuit 46 outputs a driving signal illustrated in FIG. 11.

Referring back to the FIG. 10, the explanation on ink amount determination processing is continued. Using the set parameters, the main control unit 40 generates a driving signal and outputs it to the piezoelectric element, and then performs frequency measurement processing (step S105). Frequency measurement processing is explained with reference to the timing chart illustrated in FIG. 12. In the frequency measurement processing, a clock signal CLK, a measurement command CM, and a switch control signal SS shown in FIG. 12 are signals that are transmitted from the PIO 45 of the main control unit 40 to the calculator 51 of the sub control unit 50. In addition to a command instruction dictating the execution of frequency measurement processing, information for designation of a target cartridge is contained in the measurement command CM. As have already been described, the driving signal DS is a signal that is supplied from the driving signal generation circuit 46 of the main control unit 40 to the piezoelectric element 112 of the target cartridge 100a via the sub control unit 50. The response signal RS is a signal that is generated in response to the residual vibration of the sensor after the driving signal DS is supplied.

At the timing of receiving a first pulse P1 of the switch control signal SS, the calculator 51 of the sub control unit 50 controls the second switch SW2 in accordance with the measurement command CM, which has been previously received, and puts the piezoelectric element 112 of the target cartridge 100a into a connection state with the sub control unit 50. In addition, the calculator 51 sets the first switch SW1 into a connection state and the third switch SW3 into a disconnection state at the timing of receiving the first pulse P1 of the switch control signal SS. By this means, the driving signal generation circuit 46 and the piezoelectric element 112 of the target cartridge 100a are electrically connected to each other, which makes it possible for the driving signal DS to be applied to the piezoelectric element 112. On the other hand, the amplifying unit 52 is electrically disconnected from the driving signal generation circuit 46 and the piezoelectric element 112, which prevents the driving signal DS from being applied to the amplifying unit 52.

Under such a connection state, the driving signal DS is outputted from the driving signal generation circuit 46, and the outputted signal is applied to the piezoelectric element 112 of the target cartridge 100a. At the timing of completion of applying the driving signal DS, the main control unit 40 causes the second pulse P2 to be generated in the switch control signal SS. The calculator 51 of the sub control unit 50 puts the first switch SW1 into a disconnection state at the timing of receiving the second pulse P2 of the switch control signal SS. The duration of time from the setting of the first switch SW1 into a connection state to the setting of the first switch SW1 into a disconnection state is referred to as a driving voltage application period T1.

After the driving voltage application period T1 has elapsed, the piezoelectric element 112 that has been vibration-excited by the driving signal DS outputs a response signal RS in accordance with distortion due to the vibration. After generation of the second pulse P2, the main control unit 40 generates the third pulse P3 in the switch control signal SS. The calculator 51 of the sub control unit 50 puts the third switch SW3 into a connection state at the timing of receiving the third pulse P3 of the switch control signal SS. As this result, the response signal RS coming from the piezoelectric element 112 is inputted into the amplifying unit 52.

As have already been described, the amplifying unit 52 functions as a comparator to output a digital signal in accordance with the waveform of the response signal RS as an output signal QC to the calculator 51. The calculator 51 of the sub control unit 50 calculates the vibration frequency VF of the response signal RS based on the output signal QC. Then, the calculator 51 transmits the calculated vibration frequency VF to the main control unit 40.

Upon acquisition of the vibration frequency VF, the main control unit 40 determines the ink amount of the target cartridge 100a based on the vibration frequency VF (step S106). The main control unit 40 judges that the ink amount of the target cartridge 100a is greater than, or at least equal to, a predetermined amount thereof when the vibration frequency VF is closer to the natural vibration frequency H1 described above (step S107). The main control unit 40 judges that the ink amount of the target cartridge 100a is less than a predetermined amount thereof when the vibration frequency VF is closer to the natural vibration frequency H2 described above (step S108).

The main control unit 40 transmits the result of ink amount determination to the computer 90. By this means, the computer 90 is able to notify the received result of ink amount determination to a user.

According to a printing system of the first embodiment of the invention described above, a vibration frequency that is lower than the natural vibration frequency of a target cartridge in an ink-absent state by a fixed percentage is employed as a driving signal frequency; and having such a configuration, the invention makes it possible to effectively excite the residual vibration of the piezoelectric element and thereby to amplify the amplitude of a response signal both in an ink-present state and in an ink-absent state. Thus, it is possible to improve the precision in measuring the frequency of a response signal.

In addition, according to a printing system of the embodiment of the invention, frequency information that specifies a driving signal frequency that enables the piezoelectric element of each cartridge to be excited effectively both in an ink-present state and in an ink-absent state is pre-written in the memory of each cartridge; and therefore, it is possible to acquire such a driving signal frequency with a simple configuration.

Moreover, according to a printing system of the embodiment of the invention, regardless of whether the cartridge is in an ink-present state or in an ink-absent state, it is possible to determine the amount of ink just with one execution of detection processing, which makes it further possible both to shorten the processing time of ink amount detection and to suppress the deterioration of a sensor.

### B. Exemplary Embodiment 2

According to the first exemplary embodiment of the invention described above, a driving signal frequency based on natural vibration in an ink-absent state is stored each in the memory of each ink cartridge, and the stored driving signal frequency is read out for generation of a driving signal based on the read driving signal frequency. The second exemplary embodiment of the invention is presented in the following mode. The printer 20 according to the second exemplary embodiment of the invention has, in advance, a frequency table in which each driving signal frequency is associated with a corresponding vibration frequency range, where the error range of the natural vibration frequency in an ink-absent state is divided into a plurality of vibration frequency ranges. In the memory of each ink cartridge according to the second exemplary embodiment of the invention, rank information that indicates vibration frequency ranges, within which the natural vibration frequency in an ink-absent state of each ink cartridge falls, is stored. Based on the rank table and the rank information stored in the memory of the target cartridge, the printer 20 determines a driving signal frequency. It should be noted that the system configuration according to the second exemplary embodiment is the same as that of the first exemplary embodiment.

### B1. Functional Block

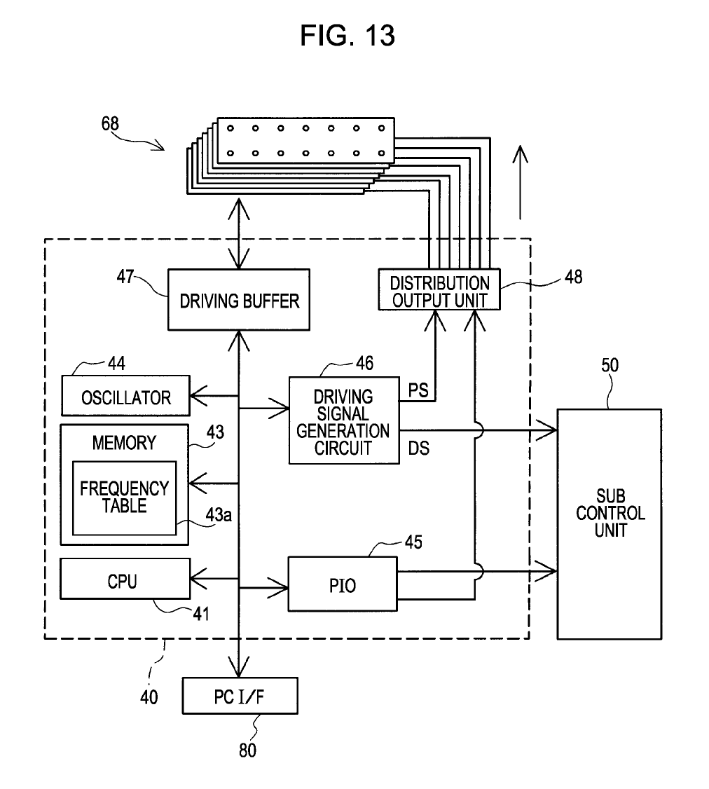

FIG. 13 illustrates, as an example, the internal configuration of the main control unit 40a according to the second embodiment of the invention. Except that a frequency table 43a is pre-stored in the memory 43, the main control unit 40a is the same as the main control unit 40 of the first embodiment of the invention.

### B2. Frequency Table

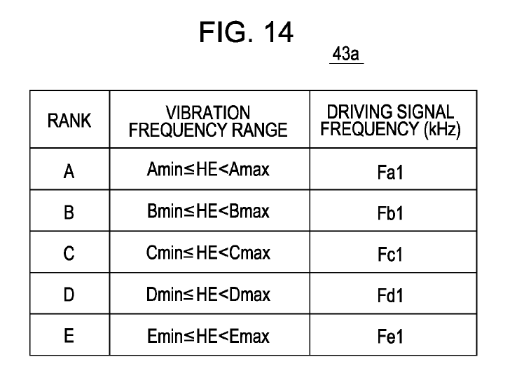

The frequency table 43a is explained below. FIG. 14 illustrates, as an example, the frequency table 43a according to this embodiment of the invention. The frequency table 43a contains rank, vibration frequency range, and driving signal frequency information. A vibration frequency range indicates each sub range, one divided section of the error range ER2 with almost the same interval as that of the others. Rank is ID information for identification of each sub range.

Driving signal frequency information is information that specifies the driving signal frequency F that is generated by the driving signal generation circuit 46. The driving signal frequency F is calculated from the following Mathematical Expression 6. It should be noted that, in this embodiment of the invention, the maximum value of each vibration frequency range is referred to as maximum frequency HE (n) max. Herein, “n” indicates ranks A-F, where, for example, the driving signal frequency Fc indicates the driving signal frequency of rank C, and the maximum frequency HE (c) max indicates the maximum frequency in the vibration frequency range of the rank C (Cmax (kHz)).

Driving Signal Frequency Fn=round [(maximum frequency HE(n)max−β%)*(1/(2k+1))] (Mathematical Expression 6)

In this embodiment of the invention, because it is assumed as k=1, the driving signal frequency F can be expressed as defined in the Mathematical Expression 7 shown below.

Driving Signal Frequency F=round [(maximum frequency HE(n)max−β%)*(⅓)] (Mathematical Expression 7)

### B3. Determination of Driving Signal Frequency

In the following discussion, an explanation is given on the determination of a driving signal frequency according to this embodiment of the invention. In this embodiment, rank information is contained in the frequency information 135 that is stored in the memory provided in the target cartridge. The rank information indicates which one is the vibration frequency range of the frequency table 43a which the natural vibration frequency HE in an ink-absent state of the target cartridge falls within. In this embodiment, it is assumed that “D” is written as the rank information in the memory 130 of the target cartridge.

The CPU 41 of the main control unit 40 acquires the rank information from the memory 130 of the target cartridge via the sub control unit 50. The CPU 41 determines a driving signal frequency based on the acquired rank information and the frequency table 43a stored in the memory 43 of the main control unit 40. More specifically, the CPU 41 refers to the frequency table 43a, and further refers to driving signal frequency information that is associated with a rank agreeing with the acquired rank information so as to determine the driving signal frequency. For example, when the acquired rank information is “D”, the CPU 41 determines the driving signal frequency (Fd 1 (kHz)) that is associated with the rank “D” as the driving signal frequency F while referring to the frequency table 43a.

According to a printing system of the second embodiment of the invention described above, a driving signal frequency is uniquely determined with respect to rank information. Therefore, it is possible to reduce the processing load of various computations for generation of a driving signal at each time of execution of ink amount detection processing, which is achieved by having driving signals for the number of ranks (e.g. five ranks according to this embodiment of the invention) in the frequency table 43a in advance. Therefore, it is possible to shorten the processing time while maintaining the precision in detecting a response signal at a high level.

### C. Variations

(1) According to the first exemplary embodiment described above, although information that specifies a driving signal frequency is stored in a memory provided in a cartridge, other information such as the natural vibration frequency of the cartridge in an ink-absent state may be stored therein. In such a variation, it is preferable that the value of β should be pre-stored in the main control unit 40. When so configured, it is possible for the CPU 41 of the main control unit 40 to acquire the natural vibration frequency of the target cartridge in an ink-absent state from the memory of the target cartridge so as to calculate a driving signal frequency by using the value β in a simple manner.

(2) As another variation, a reference frequency that is lower than the natural vibration frequency of a cartridge in an ink-absent state by a fixed percentage (β %) may be stored in the memory provided in the cartridge. According to such a variation, the CPU 41 of the main control unit 40 is able to calculate a driving signal frequency that is suitable for ink amount detection in a simple manner by multiplying the reference frequency acquired from the memory of the target cartridge by 1/(2k+1).

(3) According to the second exemplary embodiment described above, although information on ranks to which the natural vibration frequency HE of the cartridge 100a in an ink-absent state belongs is stored in a memory, as an alternative configuration, for example, the natural vibration frequency HE itself may be stored therein.

Although various exemplary embodiments of the present invention are described above, needless to say, the invention is in no case restricted to these exemplary embodiments described herein; the invention may be configured in an adaptable manner in a variety of variations without departing from the spirit thereof.

The entire disclosure of Japanese Patent Application No. 2006-134921, filed May 15, 2006 is expressly incorporated by reference herein.

What is claimed is:

1. A printing apparatus comprising:
a printing material container which is detachably mounted to the printing apparatus, the printing material container having
a memory, and
a piezoelectric element for detecting the amount of a printing material contained therein,
an acquiring section that acquires frequency information regarding the frequency of a driving signal for driving the piezoelectric element from the memory;
a supplying section that supplies the driving signal having a frequency that is determined based on the frequency information to the piezoelectric element;
a detecting section that detects a response signal that is outputted in response to vibration of the piezoelectric element after the stopping of supply of the driving signal;
a measuring section that measures vibration frequency of the piezoelectric element contained in the response signal; and
a determining section that determines whether the printing material is present in the printing material container or not based on the vibration frequency,
wherein the frequency of the driving signal is a value obtained by multiplying a second reference frequency by 1/(2k+1) (where “k” denotes any arbitrary integer of 1 or greater), the second reference frequency being lower than a first reference frequency by a fixed percentage, the first reference frequency being the vibration frequency of the piezoelectric element when the printing material is not present in the printing material container.

2. The printing apparatus according to claim 1, wherein the frequency information includes driving signal frequency information that specifies a frequency of the driving signal, and the supplying section supplies the driving signal to the piezoelectric element at a frequency specified by the driving signal frequency information.

3. The printing apparatus according to claim 1, wherein the frequency information includes a first reference frequency information that specifies the first reference frequency, and the printing apparatus further comprises a first determination section that calculates the second reference frequency based on the first reference frequency information and determines a value obtained by multiplying the calculated second reference frequency by 1/(2k+1) as the frequency of the driving signal.

4. The printing apparatus according to claim 1, wherein the frequency information includes a second reference frequency information that specifies the second reference frequency, and the printing apparatus further comprises a second determination section that determines a value obtained by multiplying the second reference frequency specified by the second reference frequency information by 1/(2k+1) as the frequency of the driving signal.

5. A printing apparatus comprising:
a printing material container which is detachably mounted to the printing apparatus, the printing material container having
a piezoelectric element for detecting the amount of a printing material contained therein, and
a memory in which frequency information on natural vibration frequency of the piezoelectric element in a state where the printing material is not present in the printing material container is stored,
an acquiring section that acquires the frequency information from the memory of an printing material container that is a detection target;
a storing section that pre-stores vibration frequency range information that associates each of a plurality of vibration frequency ranges with a corresponding driving signal frequency information that specifies the frequency of the driving signal, the plurality of vibration frequency ranges being divided out of the natural vibration frequency range within which the natural vibration frequency could fall;
a selecting section that selects, among the plurality of vibration frequency ranges, a vibration frequency range which the natural vibration frequency specified by the frequency information falls within;
a supplying section that supplies the driving signal to the piezoelectric element of the printing material container at the frequency of the driving signal that is specified by the driving signal frequency information associated with the vibration frequency range;
a detecting section that detects the response signal that is outputted from the piezoelectric element after the stopping of supply of the driving signal;
a measuring section that measures vibration frequency of the piezoelectric element contained in the response signal; and
a determining section that determines whether the printing material is present in the printing material container or not based on the vibration frequency,
wherein the frequency of the driving signal is a value obtained by multiplying a certain frequency by 1/(2k+1) (where “k” denotes any arbitrary integer of 1 or greater) the certain frequency being lower than the maximum frequency in each of the vibration frequency range by a fixed percentage.

6. A method for detecting the amount of a printing material, which is implemented by a printing apparatus which a printing material container is detachably mounted to, the printing material container having a memory and a piezoelectric element for detecting the amount of a printing material contained therein, the printing material amount detection method comprising:
acquiring frequency information regarding the frequency of a driving signal for driving the piezoelectric element from the memory;
supplying the driving signal having a frequency that is determined based on the frequency information to the piezoelectric element;
detecting a response signal that is outputted in response to vibration of the piezoelectric element after the stopping of supply of the driving signal;
measuring vibration frequency of the piezoelectric element contained in the response signal; and
determining whether the printing material is present in the printing material container or not based on the vibration frequency,
wherein the frequency of the driving signal is a value obtained by multiplying a second reference frequency by 1/(2k+1) (where “k” denotes any arbitrary integer of 1 or greater), the second reference frequency being lower than a first reference frequency by a fixed percentage, the first reference frequency being the vibration frequency of the piezoelectric element when the printing material is not present in the printing material container.

7. A method for detecting the amount of a printing material, which is implemented by a printing apparatus which a printing material container is detachably mounted to, the printing material container having a piezoelectric element for detecting the amount of a printing material contained therein and a memory in which frequency information on natural vibration frequency of the piezoelectric element in a state where the printing material is not present in the printing material container is stored, the printing material amount detection method comprising:
acquiring the frequency information from the memory of an printing material container that is a detection target;
selecting a vibration frequency range within which the vibration frequency specified by the frequency information falls among a plurality of vibration frequency ranges in the frequency information that associates each of the plurality of vibration frequency ranges with a corresponding driving signal frequency information that specifies the frequency of the driving signal where the plurality of vibration frequency ranges are divided out of the natural vibration frequency range within which the natural vibration frequency could fall;
supplying the driving signal to the piezoelectric element of the printing material container at the frequency of the driving signal that is specified by the driving signal frequency information associated with the vibration frequency range;
detecting the response signal that is outputted from the piezoelectric element after the stopping of supply of the driving signal;
measuring vibration frequency of the piezoelectric element contained in the response signal; and
determining whether the printing material is present in the printing material container or not based on the vibration frequency,
wherein the frequency of the driving signal is a value obtained by multiplying a certain frequency by 1/(2k+1) (where “k” denotes any arbitrary integer of 1 or greater) the certain frequency being lower than the maximum frequency in each of the vibration frequency range by a fixed percentage.
